(19) United States
(12) Patent Application Publication
(10) Pub. No.: US 2013/0294074 A1
(43) Pub. Date: Nov. 7, 2013

(54) LAMP

(71) Applicant: Hartmut S. ENGEL, Ludwigsburg (DE)

(72) Inventor: Hartmut S. ENGEL, Ludwigsburg (DE)

(21) Appl. No.: 13/888,295

(22) Filed: May 6, 2013

(30) Foreign Application Priority Data
May 7, 2012 (DE) 10201220754032

(51) Int. Cl. F21V 13/02

(52) U.S. Cl. CPC F21V 13/02
USPC 362/235

(57) ABSTRACT

A lamp having a housing for the reception of a plurality of illuminants, as well as a scattered light disc held in a frame are described, which is characterized in that the frame, designed in a closed manner, comprises a surrounding guide limb part, which can be received substantially in a form fitting manner in the housing, and an inwardly directed support limb part extending perpendicular to the guide limb part; and in that a light permeable, surrounding strip of predefinable color differing from the color of the scattered light disc, is arranged in an edge holding fixture formed by the guide limb part and the support limb part; and the scattered light disc, on whose full area lights is incident, being supported on this strip.

The invention relates to a lamp having a housing for the reception of a plurality of illuminants, preferably arranged in a plane, as well as possibly having a required ballast, driver and the like; and having a scattered light disc forming a direct light surface at the room side, in particular in the form of a micro prismatic surface or a satin surface or an opaque surface, wherein the scattered light disc is held in a frame which can be coupled to the housing.

Known lamps of this kind are used as installation lamps, mount lamps and possibly as lamps hung with respect to the respective ceiling.

For example, a lamp is known from the EP 2 023 035 A1 in which the illuminants are present in the region of a frame part enclosing a scattered light surface and are directed at a reflection surface arranged between a base part and a frame part. An extending space body is present between the base part and the frame part bounding the scattered light surface at the boundary side. The space body is formed by a base section, an inclined surface section which is adjacent to the base section and which extends at all sides and a one part boundary section adjoining the inclined surface section. The boundary section is configured as a support for the frame part. This space body can totally be of transparent design, so that, on an impingement with light the boundary section made as one part with the inclined surface section is also illuminated in addition to the illuminated inclined surface section. Thereby a circumferential light reflecting region arises which is optically spaced apart with respect to the scattered light surface and which is formed by the boundary section.

It is the object of the invention to configure lamps of the initially named kind, on the one hand, as simple as possible from a construction point of view and in a manner which enables a cost-effective manufacture and, on the other hand, to achieve additional esthetically pleasing characteristic light effects via the direct light surface while simultaneously ensuring a uniform illumination density distribution.

This object is satisfied starting from a lamp defined in the preamble of the main claim which is characterized in that the frame designed in a closed manner, has a surrounding guide limb part which can be received substantially in a form-fitting manner in the housing, and an inwardly directed support limb part extending perpendicular to the guide limb part and in that a light permeable, surrounding strip of predefinable color, in particular differing from the color of the scattered light disc, is arranged in an edge holding fixture formed by the guide limb part and the support limb part; and the scattered light disc, on whose full area light is incident, is supported on this strip.

It is particularly advantageous that the characteristic light effects in the transition from the frame to the direct light surface generally formed by a prismatic disc can be generated by the solution in accordance with the invention. The light effects giving the respective lamp an esthetically particularly pleasing appearance and an appearance that can be matched to the respective use of the lamp.

The light permeable strips, preferably composed of an acrylic glass, is, in particular designed rectangular in cross-section and dimensioned such that it either terminates flush with the free end of the guide limb part or slightly projects over this free end. In the first case only the end face of the strip acting as a color filter can be seen and a soft transition of the light provided by the light strip results, which light is directed inwardly towards the large white light surface surrounded by the frame. Whereas in the second case, this means in the case where a strip slightly projects over the support limb part, the irradiated projecting region makes a slightly stronger appearance, but also in this case a soft transition of the color light into the white main light surface is obtained via the end face of the strip.

With respect to the attainment of pronounced esthetic light effects the thickness of the light permeable strip is larger than the thickness of the scattered light disc, in particular at least twice as large as the thickness of the scattered light disc irradiating the white light into the space.

The surrounding light permeable strip is preferably composed of individual mitered part strips, which are arranged without a mutual connection at the support limb part, which form a closed frame and which are centered via the miter.

In accordance with a particularly preferred embodiment of the invention, the support limb part is formed perforated, in particular regularly perforated, this means that, for example, a round hole pattern, a quadratic hole, an elongate hole or the like can be provided in the support limb part, whereby a predefinable desired transparency of the frame is achieved while using the effect of the irradiation of the color light filter strip.

From the point of view of a particularly cost-effective manufacture, the housing and the frame are preferably manufactured from, in particular lasered, chamfered sheet metal blanks welded together at the abutting edges. In order to ensure a flush alignment between the frame and a surrounding housing boundary strip, which is present in the case of an installation lamp at a respective ceiling, the free end of the guide limb part, preferably formed angled, can cooperate with an abutment in the housing interior, wherein this abutment can be formed by a separately attached strip or a corresponding angled part in the housing side wall. The small gap between the housing and the guide limb part of the frame in connection with the cooperation between the angled free end of the guide limb part and the associated abutment in the housing leads to the formation of a labyrinth seal which ensures that the lamp is practically dust-tight.

In accordance with a further variant of the invention the frame is composed of a sectional frame, in particular an aluminum sectional frame, wherein the support limb part forms a sidewall of a U-section at the light side opening outwardly and with partial light being incident via a perforation of the support limb part, whose open side acts as the lateral light exit gap. In this manner it is possible to irradiate some of the light as a small indirect light portion laterally to the ceiling, wherein the indirect light effect can also be changed and/or predefined from a color point of view through the provision of the color of the strip irradiated by the light via which the light arrives in the U-section.

Instead of the use of a uniform aluminum section it can also be advantageous to merely form the surface visible from the outside, for example, as an L-shaped aluminum section and to connect this aluminum section with the support limb part formed from sheet metal material or the guide limb part formed from sheet metal material and in this manner to form an outwardly opened U-section.

The inner wall of the section opposite the perforated support limb part for the color filter strip is so designed, for example, with reflecting fins and/or inclined surfaces, that light incident into the U-section via the irradiated color filter is guided in a direction of the opening of the U-section.

Preferably illuminants in the form of LED boards or T5 fluorescent lamps are used for the simultaneous illumination of the scattered light disc and/or the prismatic surface generally cooperating with a diffusor film.

Closure springs having run-on chamfers are provided between the housing and the frame, preferably fastened at the inner wall of the housing for the releasable latching, which closure springs engage over the angled end region of the guide limb part. Alternative coupling possibilities of a known kind are, for example, a magnetic means, which coupling possibilities can likewise be used.

It is of practical advantage to use simple tension springs and retaining springs composed of bent spring wire, which are preferably positioned in the edge regions of the frame, for the fixing of the scattered light disc and/or of the components forming the scattered light surface, as well as the light permeable strips in the frame. In this manner it is possible to simply grasp into the frame and in this connection to slightly lift the scattered light disc in the central region such that the frame can be removed against the holding force of the respectively used coupling means for the opening of the lamp.

The tension springs and retaining springs comprise two spaced apart pressing clamps supported on the scattered light disc which are connected to one another by a centering limb engaging behind the end face of the scattered light disc in the gap between frame and scattered light disc and whose free ends are clamped while producing a bias in the angled part of the end region of the guide limb part and are clamped there via the bias. In order to ensure that the frame is held at the housing on an opening of the lamp and in this connection to ensure that the entire internal space of the housing is freely accessible, a pivot and holding hinge made of two end sided angled spring steel wires is provided between the housing and the frame. The spring steel wires, on the one hand, are held in the end region of two guide limbs of the frame arranged opposite one another in longitudinal holes and, on the other hand, are guided by a bore in the abutment surface of the housing associated with the respective guide limb and are angled outwardly. This pivot and holding hinge, particularly simple from a construction point of view, is composed of two simple spring wires angled at two ends and can also be mounted problem-free. This is because the spring wires must merely be threaded into the respective bore for this purpose, whereupon, through a pivoting of the angled end, the winding provided at the oppositely disposed end is introduced into the corresponding elongate hole and an exit from the elongate holes can be locked by a backward pivot process.

A variant of the design of the lamp in accordance with the invention which, in particular can also be referred to as a further development of the invention, is characterized in that the scattered light disc, in particular composed of acrylic glass, is enclosed at its end faces by a frame and wherein a respective plurality of LEDs for the coupling of light into the end faces of the scattered light disc are provided at two opposite end faces between the frame and the scattered light disc: in that the surface opposite the light irradiating surface of the scattered light disc, as well as the two free end faces of the scattered light surface are covered with reflective means, in particular totally reflective means; and in that light permeable color strip which are at least regionally impinged with light and which surround the boundary of the light irradiating side of the scattered light surface of the border side are held by frame systems which preferably are at least partly perforated or which enable an exit light color in predefinable directions.

Further advantageous embodiments and features of the invention are described in connection with the explanation of embodiments with reference to the drawing.

In the drawing there is shown:

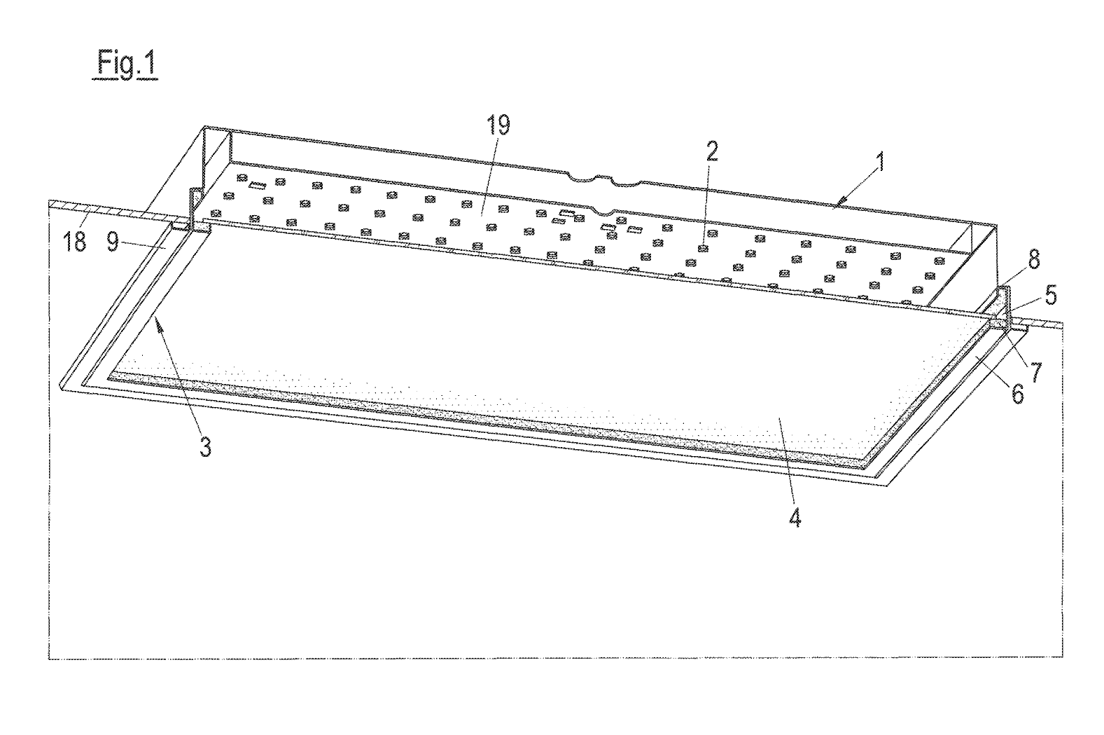

FIG. 1 a partially sectioned illustrated embodiment of an installation lamp in accordance with the invention, wherein LED boards are provided as illuminants.

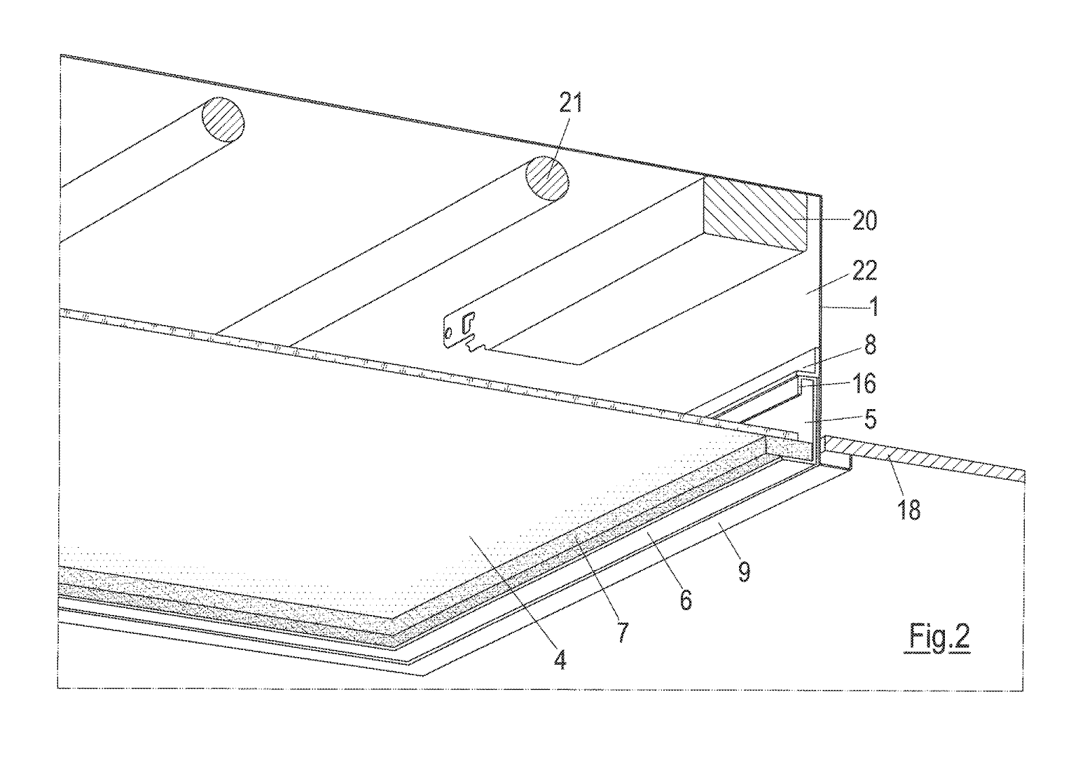

FIG. 2 a sectionally illustrated part view of an embodiment of the invention in which fluorescent lamps are used.

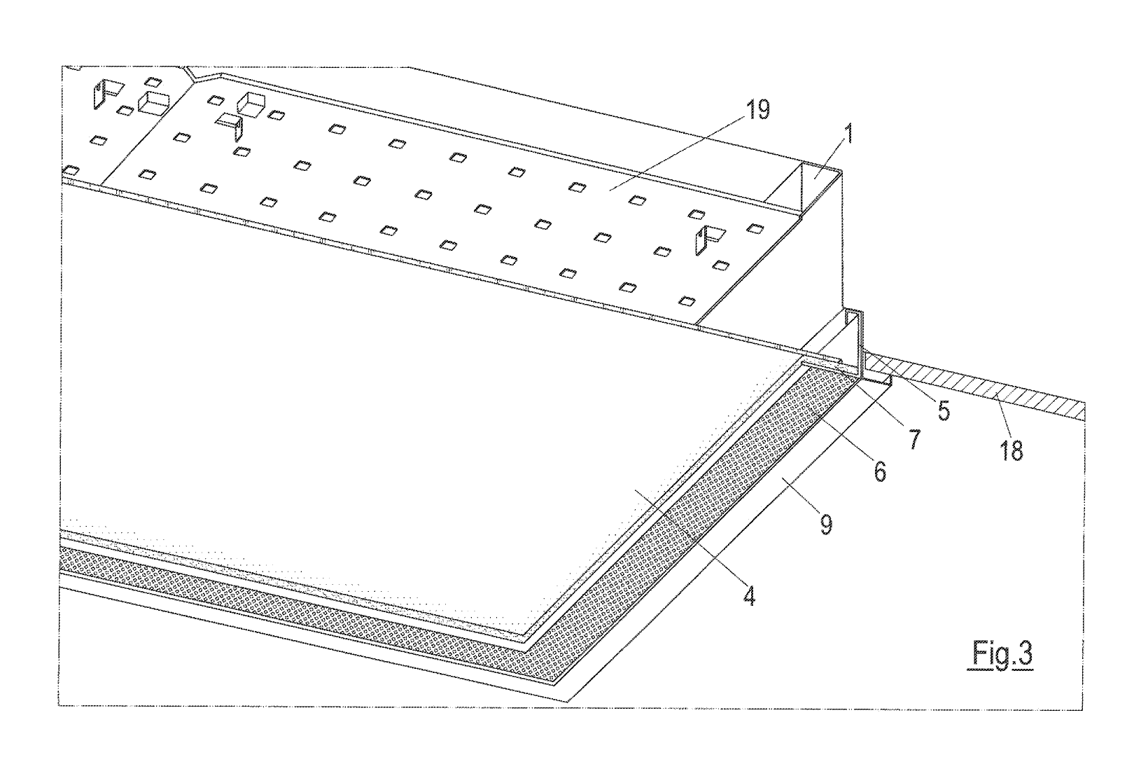

FIG. 3 a part illustration of a further embodiment.

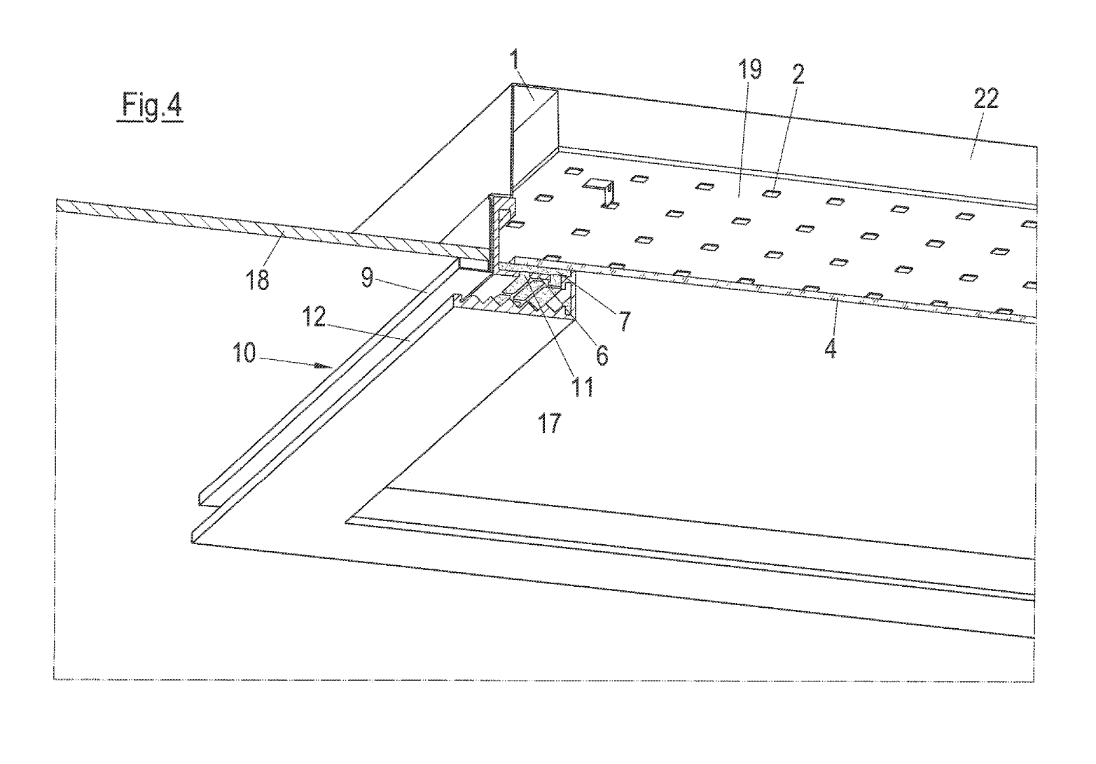

FIG. 4 a part sectional illustration of an installation lamp in accordance with the invention having lateral part light scattering;

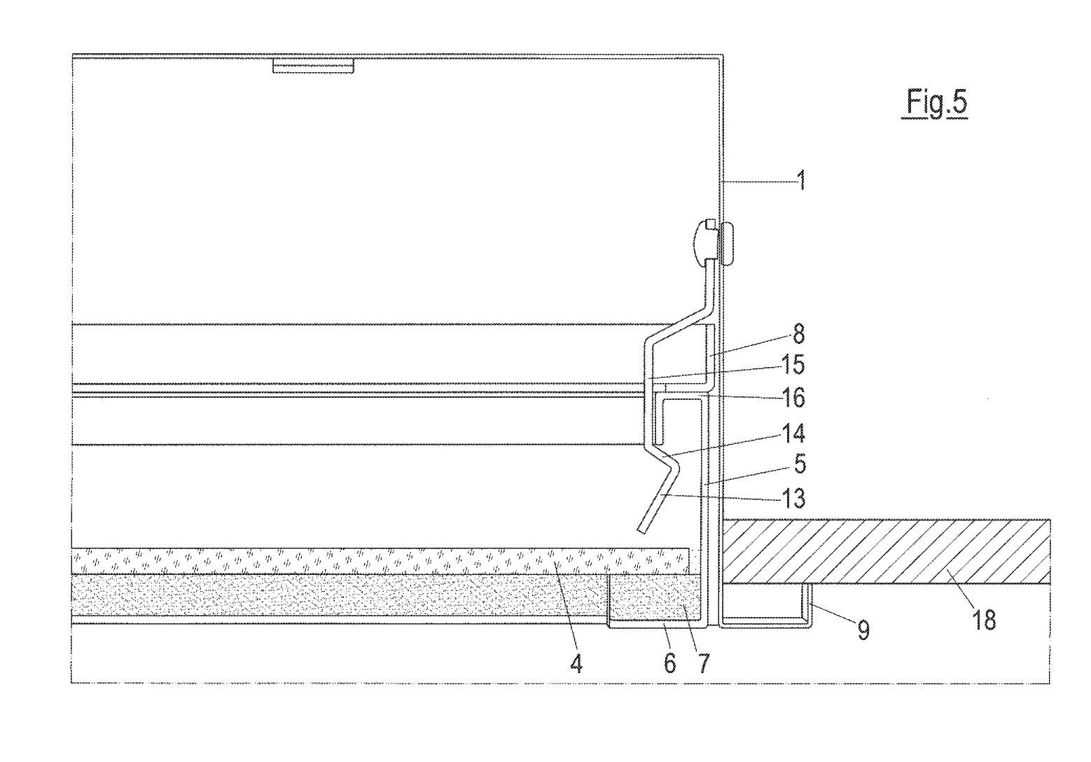

FIG. 5 a part sectional illustration of a lamp in accordance with the invention with an example of a spring latching between the housing part and the frame part;

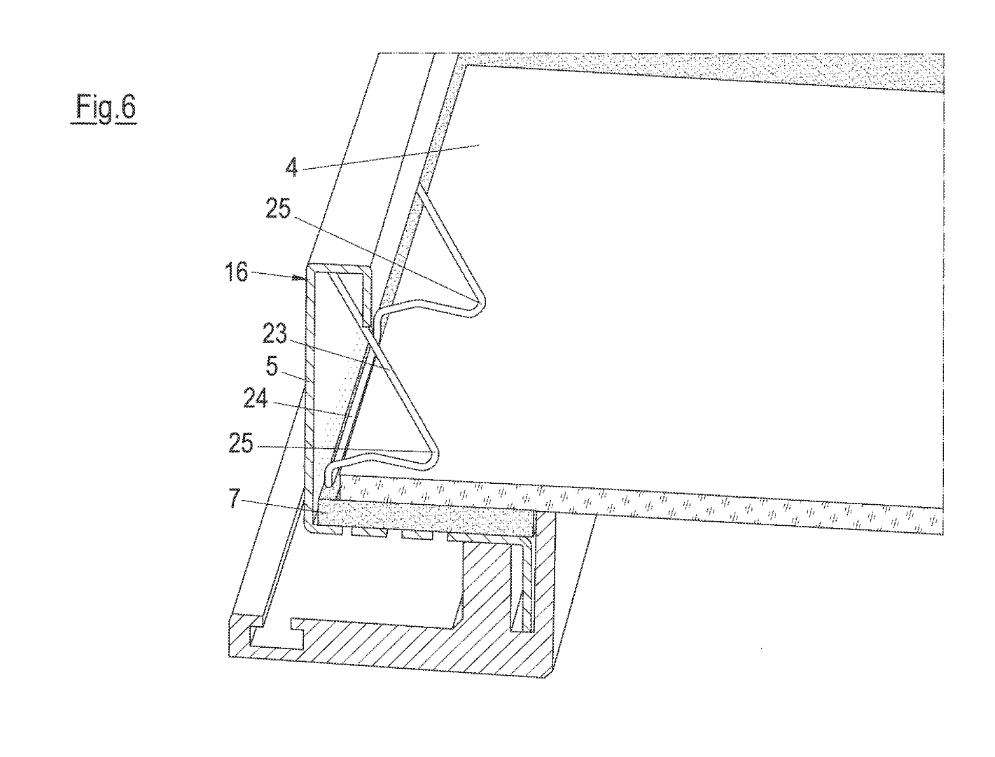

FIG. 6 a perspective part sectional illustration for the explanation of a fastening of the scattered light surface in the frame;

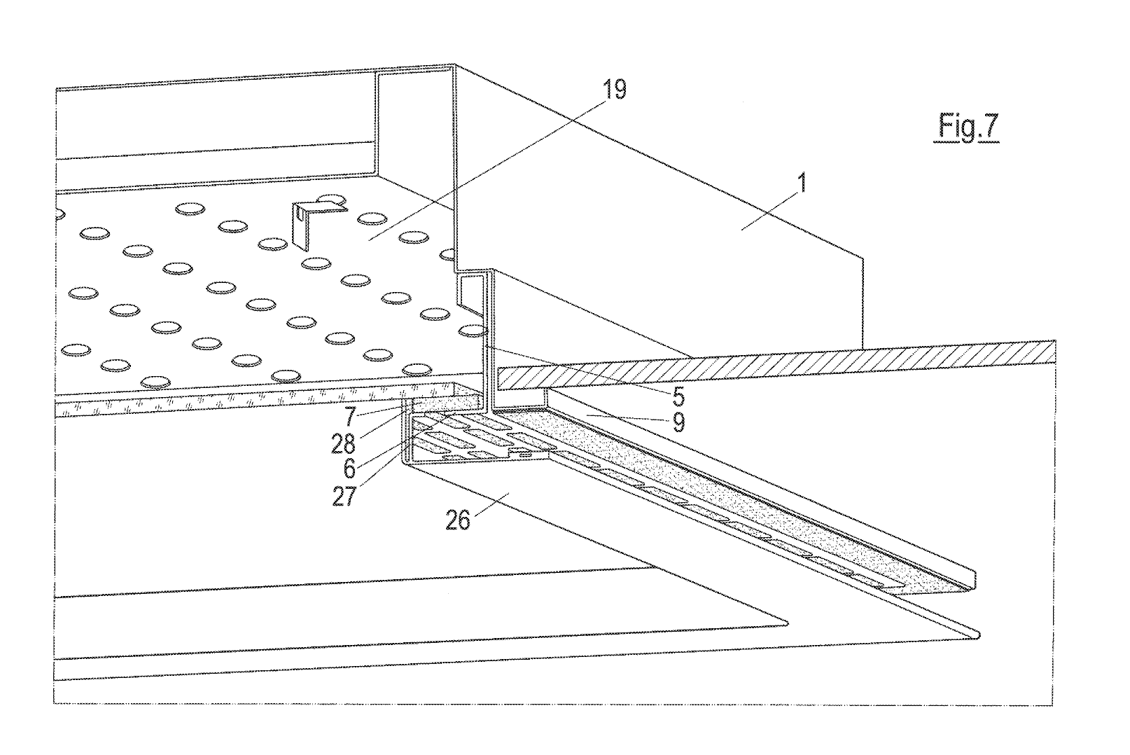

FIG. 7 a further part sectional illustration of an embodiment of the invention on use of an angled section part;

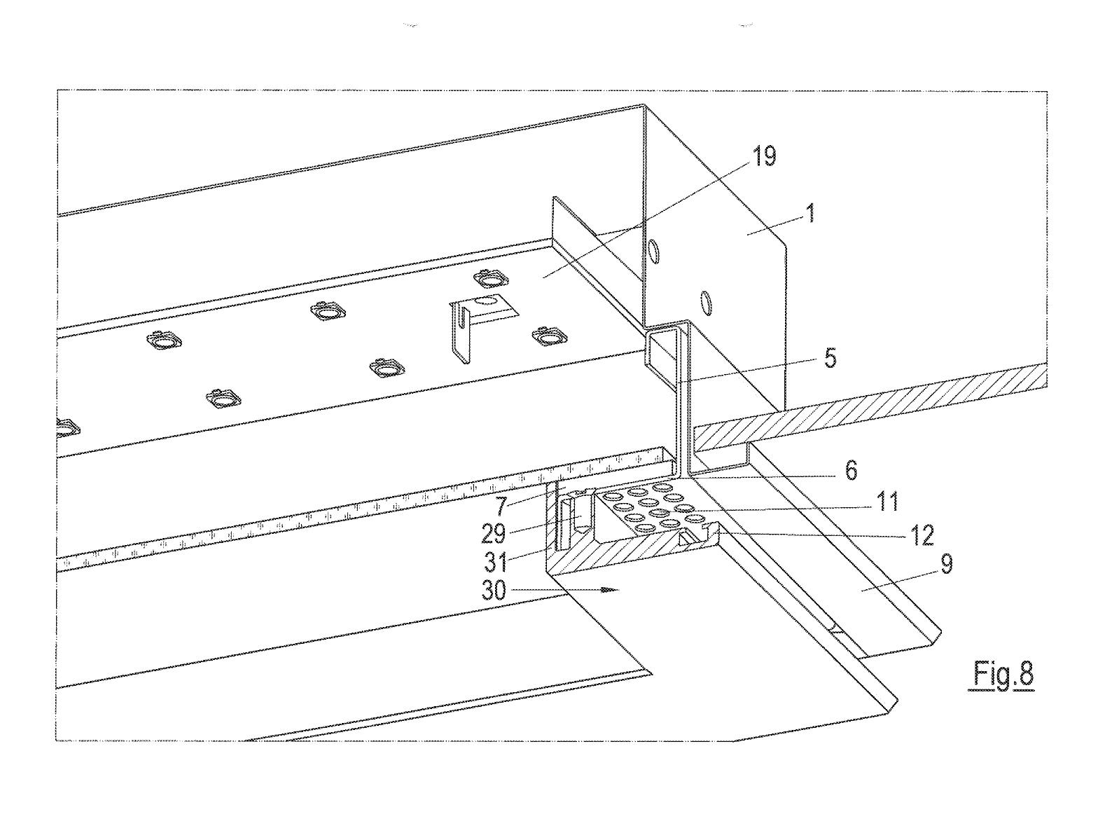

FIG. 8 a embodiment modified with respect to the design of the U-section in comparison to FIG. 7; and

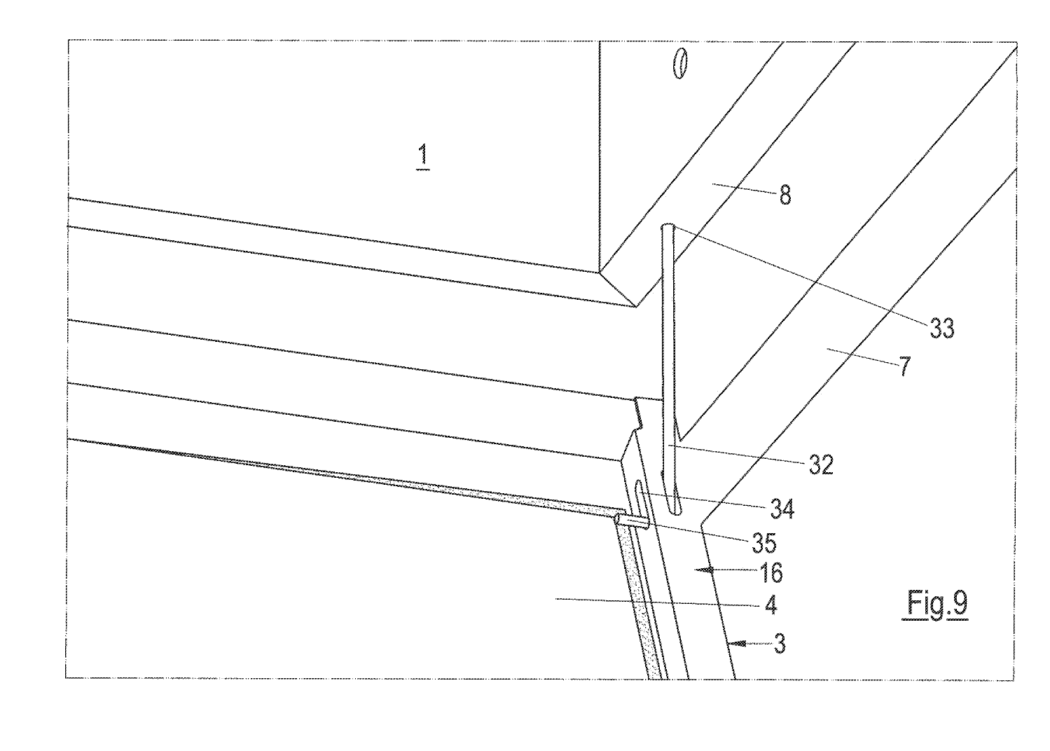

FIG. 9 a perspective part illustration of an edge region of a lamp having a down pivoted frame and a wire hinge provided for this purpose.

FIG. 1 shows a first embodiment of a lamp in accordance with the invention in the form of an installation lamp installed in a ceiling 18. This lamp comprises a housing 1, which housing serves for the reception of the illuminants, as well as the therefore required electric components and/or electronic components, as well as comprising a frame 3 which can be introduced into the housing 1 substantially in a form fitting manner and such that it terminates flush on the outside and which can be coupled to the housing via suitable means.

In the illustrated embodiment the illuminants 2 are formed by LED boards which are arranged with such a spacing with respect to the frame 3 coupled to the housing that a very uniform illumination of the overall surface of the scattered light disc 4 held in the frame 3 is obtained.

The housing 1 designed as rectangular in the present case and the associated frame 3 are cost-effectively manufactured from lasered, chamfered sheet metal blanks which are welded at the abutting edges, with the housing 1 being provided with a specific housing boundary strip 9 extending over its overall circumference intended for attachment at the ceiling 18 which boundary strip 9 is formed by a U-shaped sheet metal angle.

A surrounding abutment 8 is formed in the lateral housing walls in the housing 1 which determines the final position of the frame 3 in the coupled state, wherein the free end, in particular the free angled end of the guide limb part 5 of the frame abuts at this abutment 8. The hereby resulting narrow gap between the guide limb part 5 and the wall of the housing and/or of the abutment 8 formed by the housing and the angled end region of the guide limb part forms an effective labyrinth seal which ensures that the inner space of the lamp practically remains dust-free.

Beside the guide limb part 5 engaging in the housing, the frame 3 likewise has a surrounding support limb part 6 which is angled inwardly perpendicular with respect to the guide limb part 5 and which also forms the space sided boundary of the frame 3 and, in the state in which it is coupled to the housing 1, extends flush area-wise with the housing boundary strip 9.

A light permeable strip, for example, composed of PMMA material is arranged lying on the support limb part and indeed such that it lies in the edge region between the guide limb part 5 and the support limb part 8 and ends flush with the free end of the support limb part 6.

Preferably, the light permeable strip is composed of four chamfered part strips which are not mutually connected but rather center themselves via the miters also on heating and a corresponding expansion.

A scattered light disc 4 is arranged above the light permeable strip 7 and preferably lying directly on this light permeable strip 7 which scattered light disc 4 forms a large white uniformly illuminated light surface. This light surface is preferably formed by a prismatic surface and a thereon lying diffusor film. The scattered light disc 4 is completely impinged by the light coming from the illuminants 2, this means that in this way also the surrounding light permeable strips 7, supporting the scattered light surface 4, are correspondingly impinged with light and penetrated by radiation. As a consequence thereof characteristic light effects can be generated in the transition region between the frame 3 towards the scattered light disc 4 in dependence on the color and the thickness of the light permeable strips 7, wherein in the case of the embodiments in accordance with FIG. 1 the inner lying end faces of the light permeable strip 7 generate an intensive light effect which images with a soft transition in the scattered light disc 4 or the prismatic surface.

The embodiment in accordance with FIG. 2 shows the use of T5 fluorescent lamps 21 instead of LED boards. The housing space for the reception of the fluorescent lamps 21 is selected slightly larger and/or higher in this example in comparison to the use of LED boards, so that a large spacing with respect to the scattered light disc 4 results which ensures the uniform illumination of this disc 4. The required electronic components, in particular a ballast 20, are also arranged in the housing reception space.

The final position of the frame 3 in the coupled state is in turn defined by a surrounding abutment 8 which in the present case is composed of a separate abutment element which is connected to the housing side wall and which cooperates with the angled end region 16 of the guide limb part 5. The already mentioned gap seal for ensuring the dust-free interior of the lamp is likewise provided in this case.

In comparison to the embodiment in accordance with FIG. 1, the multipart light permeable strip 7 does not end flush with the support limb part 6 for the lamp shown in FIG. 2, but rather a certain projection of the light permeable strip 7 is provided. In this manner a targeted illuminated color edge is generated between the scattered light disc 4 and the frame 3 and the soft color transition is simultaneously ensured via the free lying end face of the light permeable strip.

The embodiment shown in FIG. 3 differs from the so far explained designs in particular in that the support limb part 6 is no longer light impermeable, but rather has a predefinable transparency due to perforations at least at a part of its width and thereby makes the width of the irradiated color strip visible. The regular perforations can also be realized as roundhole patterns, quadratic holes, elongate holes, stitch seam holes and the like.

A further embodiment of the invention is shown in FIG. 4, wherein in this case the frame 3 is completely composed of a sectional frame and the support limb part 6 forms the light-sided sidewall of a U-section 10 opening outwardly and impinged with part light through a perforation 11 of the support limb part 6. The open side of the U-section acts as the lateral light exit gap. In this connection the U-section 10 covers a part of the scattered light disc 4 over a predefinable width, wherein a certain light portion enters into the interior of the U-section and is irradiated laterally as an indirect portion and is made visible at the cover 18 via the light permeable strips 7 through perforations in the lateral sidewall of the U-section. In the interior of the U-section 10 inclined wall fins 17 or comparable reflecting elements are expediently provided in order to bring about a deflection of the light in the direction of the exit gap of the U-section.

In the mentioned embodiment, one can possibly also omit the surrounding light permeable strip and it is further possible to design the base wall of the U-section in a perforated manner in order to subsequently realize a different colored soft-light transition adjacent to the U-section towards the scattered light disc which is brought about by a color filter strip.

FIG. 5 shows a part illustration of the lamp for explaining a possible coupling principle between the housing 1 and the frame 3.

The releasable latching between the frame 3 and the housing 1 is in this case realized by means of closure springs 15 which are attached at the inner sidewalls of the housing 1 and have leading ends 13, 14 for the closure and opening movement. If the frame 3 is inserted into the housing 1 then the angled end region 16 of the guide limb part 5 glides along at the inclined surface 13 presses the spring inwardly until the inclined surface 14 becomes effective and presses the biased frame against the housing abutment 8 such that the support limb part 6 of the frame lies flush area-wise with respect to the housing boundary strip 9. On an opening of the lamp, this means on withdrawing the frame, the inclined surface 14 initially becomes effective which following its maximum deflection gives the frame free towards the inside.

The part sectional illustration in accordance with FIG. 6 shows a preferred embodiment of a holder for the scattered light surface and/or for the prismatic surface having a diffusor film in the frame.

The tension and retaining springs 23 which are expediently provided respectively in the edge regions are composed of bent spring wire and comprise two spaced apart pressing clamps 25 which are supported on the scattered light disc 4 and which are connected by a centering limb 24 which engages behind the end face of the scattered light disc 4 and generally is supported at the light permeable strip 7. The ends of the pressing clamps 25 are in turn angled downwardly approximately parallel to the centering limb 24 and engage below the U-shaped angled end region 16 of the guide limb parts 5 and indeed such that the required bias is set which is required for the pressing and centering function.

Through the arrangement of the tension and retaining springs 23 merely in the edge regions of the frame a simple opening of the lamp is enabled, since the prismatic surface is only suppressed in the edge region by the spring elements in the frame and can be slightly lifted in the central region of the prismatic surface, whereby the frame can be removed from the housing by engaging the rear of the frame.

FIG. 7 shows a deviation of the embodiment of the lamp in accordance with FIG. 4, wherein in this case a combination of an aluminum-angled frame 26 forming the outer sight surface and a sheet metal part forming the guide limb part 5 and support limb part 6 is used instead of a one part aluminum sectional frame. The support limb part 6 is provided with an additional downward angle in this case which illustrates a connection limb 27 which is fixedly connected to the vertical limb of the aluminum angled section 26, in particular by weld points. The vertical limb of the aluminum angled section 26 can have perforations 8 at its region bounding the scattered light surface or be of shortened design so that in turn a soft light transition from the light permeable strip 7 to the scattered light disc is obtained and indeed in addition to the lateral light scattering from the U-section.

FIG. 8 shows a variant of the invention in which the frame in turn is formed of a guide limb part 5 and a support limb part 6 from chamfered sheet metal in the required manner and is combined with an aluminum sectional frame 30 which forms the outer sight surfaces. The vertical limb 31 of the aluminum section 30 can in this connection adjoin at a boundary part of the support limb part 6 angled further downwardly, however, the connection between the support limb part 6 and the aluminum section 30 takes place via screws between a screw web 29 formed at the aluminum section 30 and the support limb part 6. In the outer region of the limb 12 of the aluminum section 12 a guide groove is provided in which corner connection elements can be introduced on the mounting of the frame which corner connection elements ensure the exact mutual alignment of the frame parts.

The support limb part 6 receiving the light permeable strips 7 is provided with round holes in this embodiment which enable the transition of light which irradiates the light permeable strip 7 into the U-section so that this part light of predefinable color can in turn exit laterally. The vertical limb 31 of the aluminum section 30 can likewise be perforated in the region of the light permeable strip 7 or be of shortened design so that also a soft color light transition towards the scattered light disc results.

In a perspective illustration FIG. 9 shows an end region of the housing 1 and the frame 3, wherein the frame 3 is folded away via a specifically designed, particularly simple pivot and holding hinge at the frame 1 which is, however, further held at the frame 3. A pivot and holding hinge of the shown kind is provided at two mutually opposite edge regions and is respectively composed of bent spring steel wire 32 at its ends.

A bore 33 is provided in the abutment surface 8 on the housing side through which the rectangularly bent end of the spring steel wire 32 is threaded. In the upper wall as well as in the inner lying walls of the U-shaped angled end region 16 of the guide limb part 5 the elongate holes 34 for the reception of the likewise rectangularly angled ends of the spring steel wire are provided. In the functional state illustrated in the drawing the angled wire end 35 of the spring steel wire 32 extends in the direction of the frame interior and can in this manner not exit from the elongate holes 34. The angled end of the spring steel wire 32 extends in parallel to the wall of the guide limb part 3 in the direction of the housing edge at the housing side.

If the frame supporting the scattered light disc is reintroduced into the housing 1 from the pivoted holding position then the two spring steel wires 32 forming the limb are guided at the frame side into the elongate holes 34, are pushed upwardly through the bore 33 so that in the coupled state the spring steel wire 32 extends outside of the bores 33 and in parallel to the housing wall. If a complete release of the frame from the housing should take place then the spring steel wire 32 must merely be rotated by about 90° about its longitudinal axis so that the angled wire end 35 comes to lie in parallel to the elongate holes 34 and in this manner can be released from the frame.

An embodiment of the lamp in accordance with the invention which enables an absolute flat design and even enables the omission of a common housing for illuminant reception is characterized in that a light guiding disc, for example composed of an acrylic glass, is enclosed at its end faces by a frame and with a respective plurality of LEDs for the coupling of light into the end faces of the scattered light disc being provided at two opposite end faces between the frame and the light guiding disc. The light coupled into the disc at the end face distributes itself very uniformly over the entire surface, this means a constantly desired uniform illuminant distribution results over the entire surface, wherein measures can be taken in order to respectively only allow a light exit at desired regions.

In the case of a lamp irradiating one sidedly into a space the surface of the disc lying opposite the irradiating surface is covered with completely reflecting material which is preferably also attached at the free lying end faces so that the entire coupled light can be irradiated over the room-sided surface.

The surrounding boundary region of the light irradiating surface can in turn be combined in the sense of the present invention with light permeable color strips and correspondingly design of frame systems for the obtainment of particular light effects so that light color exits and light color transitions are possible in predefinable directions.

### List of Reference Numerals

1 housing
2 illuminant
3 frame
4 scattered light disc
5 guide limb part
6 support limb part
7 light permeable strip
8 abutment
9 housing boundary strip
10 U-section
11 perforation
12 limb
13 inclined surface
14 inclined surface
15 closure spring
16 end region
17 fin
18 ceiling
19 board
20 ballast
21 T5 fluorescent lamp
22 reception space
23 tension and mounting spring
24 centering limb
25 pressing clamp
26 aluminum angled section
27 connection limb
28 perforation
29 screwing web
30 aluminum section
31 vertical limb
32 spring steel wire
33 bore
34 elongate hole
35 angled wire end

1. A lamp having a housing (1) for the reception of a plurality of illuminants (2), and having a scattered light disc (4) forming a direct light surface at the room side, wherein the scattered light disc (4) is held in a frame (3) which can be coupled to the housing (1),
wherein the frame (3), designed in a closed manner, comprises a surrounding guide limb part (5), which can be received substantially in a form fitting manner in the housing, and an inwardly directed support limb part (6) extending perpendicular to the guide limb part (5); and
the lamp having a light permeable, surrounding strip (7) of predefinable color arranged in an edge holding fixture formed by the guide limb part (5) and the support limb part (6); and the scattered light disc (4), on whose full area lights is incident, being supported on this strip (7).

2. The lamp in accordance with claim 1, wherein the predefinable color of the surrounding strip differs from the color of the scattered light disc (4).

3. The lamp in accordance with claim 1, wherein the light permeable strip (7) terminates flush with the free end of the support limb part (6) or is designed as slightly projecting.

4. The lamp in accordance with claim 3, wherein the light permeable strip is rectangular in cross-section.

5. The lamp in accordance with claim 1, wherein the light permeable strip (7) is composed of individual mitered part strips which are arranged in a self-centering manner at the support limb part (6) without mutual connection; and
wherein a thickness of the light permeable strip (7) is larger than the thickness of the scattered light disc (4), in particular twice as large as the thickness of the scattered light disc (4).

6. The lamp in accordance with claim 1, wherein the support limb part (6) is formed perforated.

7. The lamp in accordance with claim 1, wherein the guide limb part has a free end, the free end of the guide limb part (5) cooperating with an abutment (8) in the inner housing and thereby, on the one hand, ensures a flush alignment between the frame (3) and a surrounding housing border strip (9) and, on the other hand, a dust proof labyrinth seal is formed between the housing (1) and the frame (3).

8. The lamp in accordance with claim 7, wherein the free end is an angled free end.

9. The lamp in accordance with claim 7, wherein the housing (1) and the frame (3) are manufactured from cut sheet metal parts.

10. The lamp in accordance with claim 7, wherein the housing (1) and the frame (3) are manufactured from lasered sheet metal parts, beveled sheet metal parts and sheet metal parts welded at the abutment edges.

11. The lamp in accordance with claim 6, wherein the frame (3) is composed of a sectional frame, wherein the support limb part (6) forms the sidewall of a U-section (10) at the light side opening outwardly and with partial light incident via a perforation (11) of the support limb part (6), whose open side acts as the lateral light exit gap.

12. The lamp in accordance with claim 8, wherein the U-section (10) covers a boundary region of the scattered light disc (4) and the free end of the limb (12) of the U-section opposite the support limb part (6) is flush with the outer edge of the housing border strip (9).

13. The lamp in accordance with claim 11, wherein the sectional frame is composed of a one part aluminum sectional frame or of aluminum angle bracket section frames forming the outer sight surfaces and angled sheet metal parts which form the support limb parts (6) and the guide limb parts (5), with the sections and sheet metal parts being welded to one another.

14. The lamp in accordance with claim 11, wherein the inner wall of the U-section (10) opposite the perforated support limb part (6) is provided with reflective fins (17) which guide light in the direction of the opening of the U-section (10).

15. The lamp in accordance with claim 1, wherein the light means (2) are composed of LED boards or T5-fluorescent lamps for the uniform illumination of the scattered light disc (4) and/or of the prismatic surface cooperating with a diffusor foil.

16. The lamp in accordance with claim 1, wherein magnetic means or closure springs (15) having run-on chamfers (13, 14) attached at the inner wall of the housing (1) are provided for the releasable latching between the housing (1) and the frame (3), which closure springs (15) engage over the angled end region (16) of the guide limb part (5).

17. The lamp in accordance with claim 1, wherein tension springs and retaining springs (23) are provided in the frame (3) for the fixing of the scattered light disc (4) and the light permeable strips (7), wherein the tension springs and holding springs (23) are composed of bent spring wire and comprise two spaced apart pressing clamps (25) supported on the scattered light disc (4) which pressing clamps (25) are connected to one another through a centering limb (24) engaging behind the end face of the scattered light disc (4) and whose free end is clamped while producing a preload in the angled part of the end region (16) of the guide limb part (5).

18. The lamp in accordance with claim 17, wherein the tension springs and the retaining springs (23) are arranged neighboring the frame edges.

19. The lamp in accordance with claim 1, further comprising a pivot and holding hinge made of two end sided angled spring steel wires (32) which are arranged between the housing (1) and the frame (3) which, on the one hand, are held in the end region (15) of two guide limbs (5) of the frame arranged opposite one another in longitudinal holes (34) and which, on the other hand, are guided by a bore (33) in the abutment surface (8) of the housing (1) associated with the respective guide limb (5) and are angled outwardly.

20. The lamp in accordance with claim 1, wherein the housing (1) is designed as an installation housing and the housing border strip (9) formed by a U-shaped bend forms a ceiling stop for the housing (1).

21. A lamp comprising a scattered light disc having end faces, a light irradiating surface and a surface opposite the light irradiating surface, wherein the light irradiating surface has a boundary at a border side, wherein the scattered light disc is enclosed at its end faces by a frame and wherein a respective plurality of LEDs for the coupling of light into the end face of the scattered light disc are provided at two opposite end faces between the frame and the scattered light disc;
wherein the surface opposite the light irradiating surface of the scattered light disc, as well as the two free end faces of the scattered light surface are covered with reflective means; and
wherein light permeable color strips which are at least regionally impinged with light and which surround the boundary of the light irradiating side of the scattered light surface at the border side are held by frame systems.

22. The lamp in accordance with claim 21, wherein the color strips are at least partly perforated or enable an exit light color in predefinable directions possibly combined with an exit light color through perforations.

23. The lamp in accordance with claim 21, wherein the frame (3), designed in a closed manner, comprises a surrounding guide limb part (5), which can be received substantially in a form fitting manner in the housing, and an inwardly directed support limb part (6) extending perpendicular to the guide limb part (5); and
the lamp having a light permeable, surrounding strip (7) of predefinable color arranged in an edge holding fixture formed by the guide limb part (5) and the support limb part (6); and the scattered light disc (4), on whose full area lights is incident, being supported on this strip (7).
